(19) United States
(12) Patent Application Publication
(10) Pub. No.: US 2026/0200270 A1
(43) Pub. Date: Jul. 16, 2026

(54) TIRE

(71) Applicant: BRIDGESTONE CORPORATION, Chuo-ku, Tokyo (JP)

(72) Inventors: Takehito KAMADA, Chuo-ku, Tokyo (JP); Yujiro ITO, Chuo-ku, Tokyo (JP); Hironori HOSHINO, Chuo-ku, Tokyo (JP)

(73) Assignee: BRIDGESTONE CORPORATION, Chuo-ku, Tokyo (JP)

(21) Appl. No.: 19/134,745

(22) PCT Filed: Nov. 14, 2023
(86) PCT No.: PCT/JP2023/040967

§ 371 Date: Jun. 2, 2025

(30) Foreign Application Priority Data
Dec. 16, 2022 (JP) 2022-201493

(51) Int. Cl. B60C 13/00

(52) U.S. Cl. CPC B60C 13/001

(57) ABSTRACT

A tire of this disclosure comprises a marking part provided on an outer surface of a side portion, that is visually recognizable from an outside of the tire through vision, wherein the marking part comprises at least one of: a plurality of area partition portions arranged at intervals in the tire circumferential direction to partition an entire area in the tire circumferential direction into a plurality of areas; and one or more area identification portions which make each of the plurality of areas partitioned by the plurality of area partition portions be uniquely identifiable, and a plurality of area partition identification portions arranged at intervals in the tire circumferential direction to partition an entire area in the tire circumferential direction into a plurality of areas each of which is uniquely identifiable.

### TECHNICAL FIELD

This disclosure relates to a tire.

### BACKGROUND

For example, in the case of ultra-heavy-duty tires used in harsh environments, such as tires for construction machinery and tires for mining vehicles, damage to part of the tread portion or the side portion may occur due to rocks, rubble, etc. In such cases, the tire with the damaged part repaired (repaired tire) may continue to be used. Patent Document 1 discloses this type of repaired tire.

### CITATION LIST

### Patent Literature

PTL 1: JP 2015-168127 A

### SUMMARY

### Technical Problem

For example, in order to monitor the durability of the repaired area of a repaired tire, it is preferable that the location of the repaired area of the repaired tire can be easily identified. However, in some cases, for example when the repair area is covered in mud, it may not be possible to easily identify the repaired area from the outside. In addition, it is sometimes desirable to be able to easily identify the position in the tire circumferential direction, not only for ultra-heavy-duty tires, but also for tires used for other purposes, for example, to identify the location of embedded communication devices such as RF tags.

An object of the present disclosure is to provide a tire comprising a marking part that allows easy identification of a position in the tire circumferential direction.

### Solution to Problem

The tire as the first aspect of this disclosure is:
(1)
a tire comprising a marking part provided on an outer surface of a side portion, that is visually recognizable from an outside of the tire through vision, wherein
the marking part comprises at least one of:
   a plurality of area partition portions arranged at intervals in the tire circumferential direction to partition an entire area in the tire circumferential direction into a plurality of areas; and one or more area identification portions which make each of the plurality of areas partitioned by the plurality of area partition portions be uniquely identifiable, and
   a plurality of area partition identification portions arranged at intervals in the tire circumferential direction to partition an entire area in the tire circumferential direction into a plurality of areas each of which is uniquely identifiable.

The tire as one embodiment of this disclosure is:
(2)
the tire as described in the above (1), wherein the marking part comprises the plurality of area partition portions and the one or more area identification portions, and
each of the plurality of area partition portions is longer in a tire radial direction than in the tire circumferential direction.

The tire as one embodiment of this disclosure is:
(3)
the tire as described in the above (2), wherein each of the plurality of area partition portions has a length of at least one-third of a height of the tire in the tire radial direction.

The tire as one embodiment of this disclosure is:
(4)
the tire as described in the above (2) or (3), wherein each of the plurality of area partition portions protrudes on the outer surface of the side portion.

The tire as one embodiment of this disclosure is:
(5)
the tire as described in any one of the above (2) to (4), wherein each of the plurality of area partition portions has a different hue from surroundings in the tire circumferential direction.

The tire as one embodiment of this disclosure is:
(6)
the tire as described in any one of the above (2) to (5), wherein each of the plurality of area partition portions comprises a light-emitting area.

The tire as one embodiment of this disclosure is:
(7)
the tire as described in any one of the above (2) to (6), wherein the plurality of area partition portions are arranged at equal intervals in the tire circumferential direction.

The tire as one embodiment of this disclosure is:
(8)
the tire as described in any one of the above (2) to (7), wherein each of the plurality of area partition portions is a line-shaped partition portion that extends linearly in the tire radial direction.

The tire as one embodiment of this disclosure is:
(9)
the tire as described in any one of the above (2) to (8), wherein the one or more area identification portions are arranged in only half or fewer of the plurality of areas that are partitioned by the plurality of area partition portions.

The tire as one embodiment of this disclosure is:
(10)
the tire as described in any one of the above (2) to (9), wherein the one or more area identification portions protrude on the outer surface of the side portion.

The tire as one embodiment of this disclosure is:
(11)
the tire as described in the above (1) wherein, the marking part comprises the plurality of area partition identification portions, and
the plurality of area partition identification portions are arranged at equal intervals in the tire circumferential direction with different appearances that are mutually identifiable.

The tire as one embodiment of this disclosure is:
(12)
the tire as described in the above (1) wherein, the marking part comprises the plurality of area partition identification portions, and
the plurality of area partition identification portions are arranged at different intervals in the tire circumferential direction with same appearances that are mutually unidentifiable.

### Advantageous Effect

According to the present disclosure, it is possible to provide a tire comprising a marking part that allows easy identification of a position in the tire circumferential direction.

### BRIEF DESCRIPTION OF THE DRAWINGS

In the accompanying drawings:

FIG. 1 is a cross-sectional view in the tire width direction of a tire as the first embodiment of the present disclosure;

FIG. 2 is a side view of the tire illustrated in FIG. 1;

FIG. 3 illustrates an example of a variant of a marking part illustrated in FIG. 2;

FIG. 4 illustrates an example of a variant of a marking part illustrated in FIG. 2;

FIG. 5 is a cross-sectional view taken along line I-I in FIG. 2;

FIG. 6 is a cross-sectional view taken along line II-II in FIG. 2;

FIG. 7 is a side view of a tire as the second embodiment of the present disclosure;

FIG. 8 provides an example of a variant of a marking part illustrated in FIG. 7;

FIG. 9 is a cross-sectional view taken along line III-III in FIG. 7; and

FIG. 10 illustrates an example of a variant of a marking part illustrated in FIG. 7.

### DETAILED DESCRIPTION

Hereinafter, an embodiment of a tire according to the present disclosure will be described by way of example with reference to the drawings. In each drawing, the same components are given by the same reference numerals. In this specification, the tire width direction refers to the direction parallel to the central axis of the tire. The tire radial direction refers to a radial direction perpendicular to the central axis of the tire and centered on the central axis. The tire circumferential direction refers to the direction in which the tire rotates about the central axis of the tire.

### First Embodiment

The following is an example of a pneumatic tire 1 (hereinafter, simply referred to as a “tire 1”) as one embodiment of the present disclosure. There is no particular restriction on the type of the tire 1. In this embodiment, the tire 1 is a super heavy-duty tire for construction machinery, mining vehicles, etc., but the tire according to the present disclosure may also be a heavy-duty tire for trucks, buses, etc., or a passenger vehicle tire.

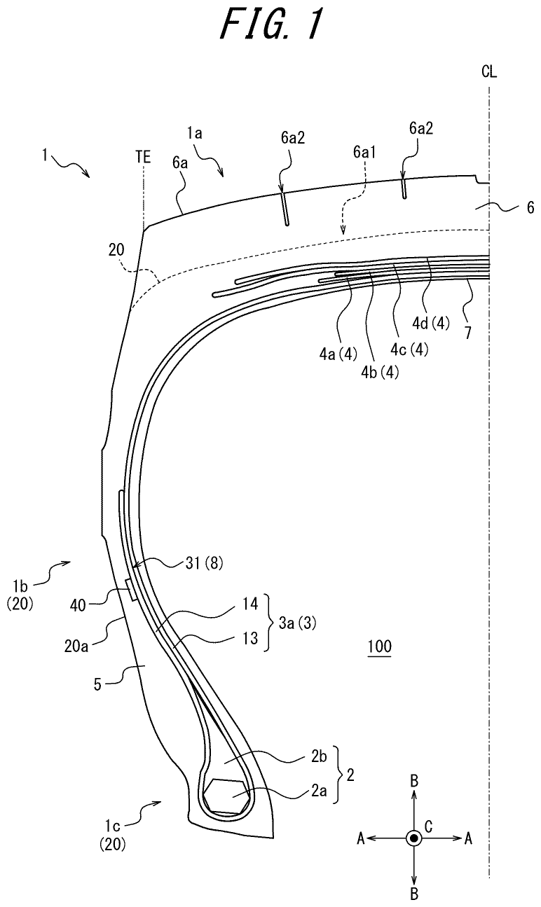

FIG. 1 is a cross-sectional view of the tire 1 in the tire width direction. As the tire 1 illustrated in FIG. 1 is symmetrical with respect to the tire equatorial plane CL, FIG. 1 illustrates a cross-sectional view of the tire in the tire width direction A on one side only, across the tire equatorial plane CL. However, the tire 1 may have an asymmetric configuration with respect to the tire equatorial plane CL.

As illustrated in FIG. 1, the tire 1 comprises a tread portion 1a, a pair of sidewall portions 1b that extend from both ends in the tire width direction A of the tread portion 1a to the inner side in the radial direction B, and a pair of bead portions 1c provided at the inner side in the radial direction B of each sidewall portion 1b. Here, the “tread portion la” refers to the part sandwiched between the tread edges TE on both sides in the tread width direction A. In addition, the “bead portion 1c” refers to the part where a bead member 2 described below is located in the tire radial direction B. And the “sidewall portion 1b” refers to the area between the tread portion la and the bead portion 1c. The “tread edge TE” refers to the outermost position of the contact patch in the tire width direction when the tire 1 is mounted on a prescribed applicable rim, filled with the prescribed internal pressure, and loaded with the maximum load.

The tire 1 comprises the bead member 2, a carcass 3, a belt 4, a side rubber 5, a tread rubber 6, an inner liner 7, and a communication device 40.

The bead member 2 is embedded in the bead portion 1c. The bead member 2 comprises a pair of bead cores 2a and a rubber stiffener 2b located on the outer side in relation to each bead core 2a in the tire radial direction B. The bead core 2a comprises a plurality of bead cords that are coated with rubber. The bead cord is formed of steel cords. The steel cord can, for example, be made up of a steel monofilament or a stranded wire.

The carcass 3 may be a so-called radial carcass. The carcass 3 comprises a carcass ply 3a that straddles in a toroidal shape between the pair of bead cores 2a. The carcass ply 3a is folded from the inner side to the outer side in the tire width direction A around each bead core 2a. In addition, the carcass ply 3a comprises a plurality of carcass cords.

The carcass 3 in this embodiment comprises only one carcass ply 3a, but this is not limited to this configuration. The carcass 3 may comprise two or more carcass plies 3a. The carcass cords of the carcass plies 3a may be metal cords such as steel cords.

More specifically, the carcass ply 3a of this embodiment comprises a ply main body portion 13 that straddles between the pair of bead cores 2a, and a ply turn-up portion 14 that is located on the outer side of each bead core 2a in the tire width direction A. The ply turn-up portion 14 is connected to the ply main body portion 13 and is formed by folding around the pair of bead cores 2a. As illustrated in FIG. 1, in the tire 1 of this embodiment, the stiffener 2b that extends taperingly from the bead core 2a to the outer side in the tire radial direction B is arranged, between the ply main body portion 13 and the ply turn-up portion 14 in the tire width direction A.

The belt 4 comprises one or more (four in FIG. 1) belt layers 4a to 4d that are arranged on the outer side in the tire radial direction B in relation to the crown portion of the carcass 3. Each belt layer 4a to 4d of the belt 4 illustrated in FIG. 1 includes belt cords coated with rubber. Each belt layer 4a to 4d may be an inclined belt layer or a circumferential belt layer. The inclined belt layer may be composed of belt plies that include belt cords arranged at an inclination angle greater than 10° and 40° or less with respect to the tire circumferential direction C. In addition, the circumferential belt layer may be composed of belt plies that include belt cords arranged parallel to the tire circumferential direction C, or inclined at an angle of 10° or less, preferably 5° or less, with respect to the tire circumferential direction C. The belt cords in each belt layer 4a to 4d are composed of metal cords such as steel cords. The belt 4 illustrated in FIG. 1 comprises a structure with four belt layers 4a to 4d, but it may also be a belt 4 with three or fewer belt layers, or a belt 4 with five or more belt layers.

The side rubber 5 covers the outer side of the carcass 3 in the tire width direction A. The side rubber 5 also constitutes an outer surface 20a on the outer side in the tire width direction A of a side portion 20 consisting of the sidewall portion 1b and the bead portion 1c.

A tread rubber 6 covers the outer side in the radial direction B of the carcass 3. The tread rubber 6 constitutes the tread surface 6a of the tire 1, which is the outer surface of the tread portion 1a on the outer side in the tire radial direction B. In addition, the tread rubber 6 is continuous with the side rubber 5 on the outer side in the tire radial direction B. The tread surface 6a formed by the tread rubber 6 has a lug groove 6al extending in the tire width direction A formed thereon. The lug groove 6al penetrates to the outer side of the tread rubber 6 in the tire width direction A. In other words, the outer ends of the lug grooves 6al in the tire width direction A do not terminate within the tread surface 6a, but open onto the tire side surfaces. In addition to the lug groove 6a1, a circumferential groove 6a2 extending in the tire circumferential direction C may be formed on the tread surface 6a.

The inner liner 7 covers the tire cavity 100 side in relation to the carcass 3. More specifically, the inner liner 7 of the present embodiment covers the tire cavity 100 side of the ply body portion 13 of the carcass ply 3a and constitutes the tire inner surface facing the tire cavity 100.

As illustrated in FIG. 1, the communication device 40 may be embedded inside the side portion 20. However, the location of the communication device 40 is not particularly limited, and it may be attached to the inner surface of the tire, for example. The position on the inner surface of the tire where the communication device 40 is attached may be the inner surface of the tread portion 1a, or the inner surface of the side portion 20. In addition, the communication device 40 may also be embedded inside the tread portion 1a, for example.

The communication device 40 only needs to be configured to be able to wirelessly communicate with a predetermined device outside the tire 1, and the configuration of the communication device 40 is not particularly limited. For example, an RF tag can be used as the communication device 40. The RF tag as the communication device 40 is capable of wireless communication with a reader or reader/writer (hereinafter, referred to as a “reader or the like”) located outside the tire 1. The RF tag may be, for example, a passive RF tag that operates using power supplied from a reader or the like located outside the tire 1. Specifically, the RF tag as the communication device 40 is capable of receiving information transmitted by radio waves or magnetic fields from the antenna section of a reader or the like. The antenna section of the RF tag generates power through rectification (in the case of radio waves) or resonance (in the case of magnetic fields), and a storage section and a control section of the RF tag execute specified operations. The control section of the RF tag, for example, can read out information from the storage section of the RF tag and transmit the information back (send it) to the reader or the like from the antenna section via radio waves or a magnetic field. The antenna section of the reader or the like receives the radio waves or magnetic fields from the RF tag. The control section of the reader or the like can obtain the information stored in the storage section of the RF tag by extracting the received information. The storage section and the control section of the RF tag described above may be configured, for example, using an integrated circuit (IC chip) that includes non-volatile memory.

The communication device 40 may be embedded in the side portion 20, in a covered communication device state, for example, in which the periphery of the communication device is covered in advance with a covering rubber.

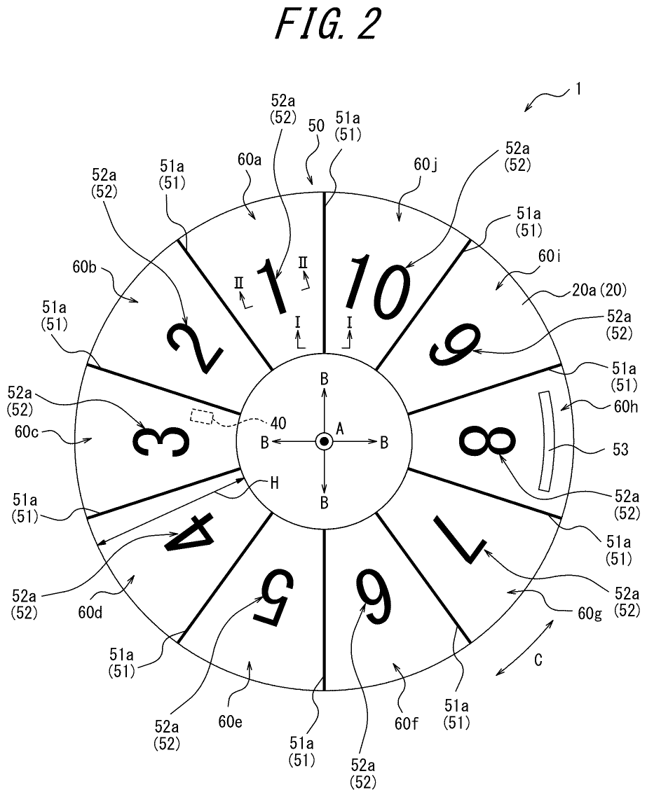

Next, referring to FIG. 2, a marking part 50 provided on the outer surface 20a of the side portion 20 will be described. FIG. 2 is a side view of the tire 1 viewed along the tire width direction A.

As illustrated in FIG. 2, the marking part 50 is configured to be visually recognizable through vision from the outside of the tire 1. Here, the marking part 50 being “visually recognizable through vision from the outside of the tire 1” means that the marking part 50 can be identified, from the outside of the tire 1 through vision, from the surroundings around the marking part 50.

As illustrated in FIG. 2, the marking part 50 of this embodiment comprises a plurality of area partition portions 51, one or more area identification portions 52, and an information display portion 53.

The plurality of area partition portions 51 partition the entire tire circumferential direction C into a plurality of areas 60a to 60j. In the example illustrated in FIG. 2, each of the plurality of area partition portions 51 is a line-shaped partition portion 51a extending linearly in the tire radial direction B. The plurality of line-shaped partition portions 51a extend radially from the central axis of the tire. As illustrated in FIG. 2, the plurality of line-shaped partition portions 51a, which serve as the plurality of area partition portions 51 in this embodiment, are arranged at intervals in the tire circumferential direction C. More specifically, in this embodiment, the plurality of line-shaped partition portions 51a, which serve as the plurality of area partition portions 51, are arranged at equal intervals in the tire circumferential direction C on the outer surface 20a of the side portion 20. In this embodiment, the ten line-shaped partition portions 51a partition the outer surface 20a of the side portion 20 into 10 areas 60a to 60j in the tire circumferential direction C. However, it is sufficient that at least two area partition portions 51 are provided. Therefore, the area partition portions 51 may be configured to partition the outer surface 20a of the side portion 20 into less than nine areas, or it may be configured to partition it into eleven or more areas. However, it is preferable that the area partition portions 51 partition in the tire circumferential direction C into ten or more areas. In this way, the position in the tire circumferential direction C can be more accurately identified.

The plurality of line-shaped partition portions 51a, which serve as the plurality of area partition portions 51 in this embodiment, are arranged at equal intervals in the tire circumferential direction C with the same appearances that are mutually unidentifiable through vision. In other words, the plurality of area partition portions 51 of this embodiment partition the outer surface 20a of the side portion 20 into the plurality of areas 60a to 60j in the tire circumferential direction C, but each of the plurality of areas 60a to 60j cannot be uniquely identified based only on the plurality of area partition portions 51.

In response to this, the marking part 50 of this embodiment comprises the one or more area identification portions 52 in addition to the plurality of area partition portions 51. The one or more area identification portions 52 are configured to make each of the plurality of areas 60a to 60j partitioned by the plurality of area partition portions 51 to be uniquely identifiable through vision. Specifically, the one or more area identification portions 52 of this embodiment consist of a plurality of numeral shape portions 52a that make each of the plurality of areas 60a to 60j be uniquely identifiable. The plurality of numeral shape portions 52a, which serve as a plurality of area identification portions 52 in this embodiment, are respectively arranged in each of the plurality of areas 60a to 60j and have different appearances that are mutually identifiable. Specifically, the plurality of numeral shape portions 52a of this embodiment have the shapes of the numerals 1 to 10, which are arranged in the plurality of areas 60a to 60j, respectively. This makes it possible to uniquely identify each of the plurality of areas 60a to 60j. However, the plurality of area identification portions 52 only need to be in mutually identifiable appearances, and are not limited to the plurality of numeric shape portions 52a provided in this embodiment. The plurality of area identification portions 52 may be symbol shape portions that have shapes that are mutually identifiable through vision, for example. In addition, the plurality of area identification portions 52 may be configured so that the plurality of areas 60a to 60j can be uniquely identified by the presence or absence of the area identification portions 52, in addition to or instead of the distinction made by the mutually identifiable shapes of the numerical shape portions 52a, the symbol shape portions, etc., as described above.

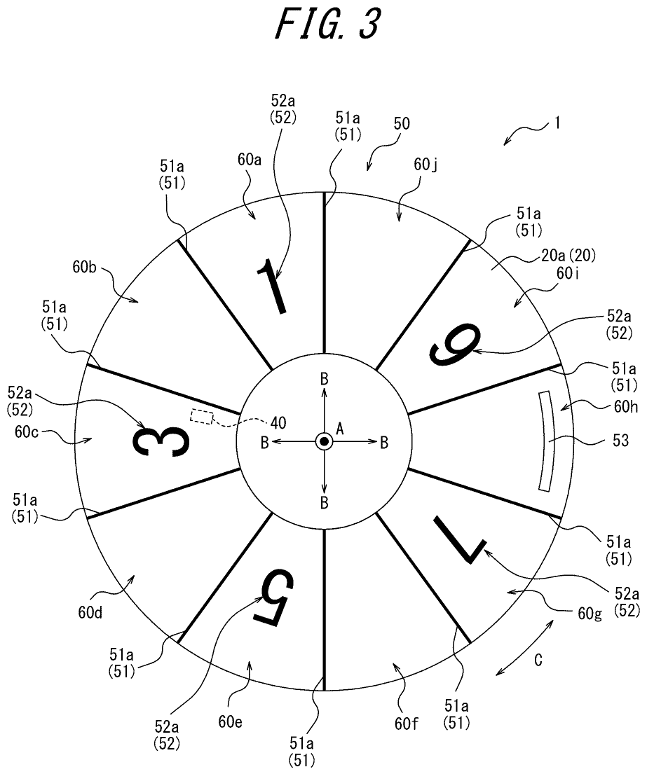

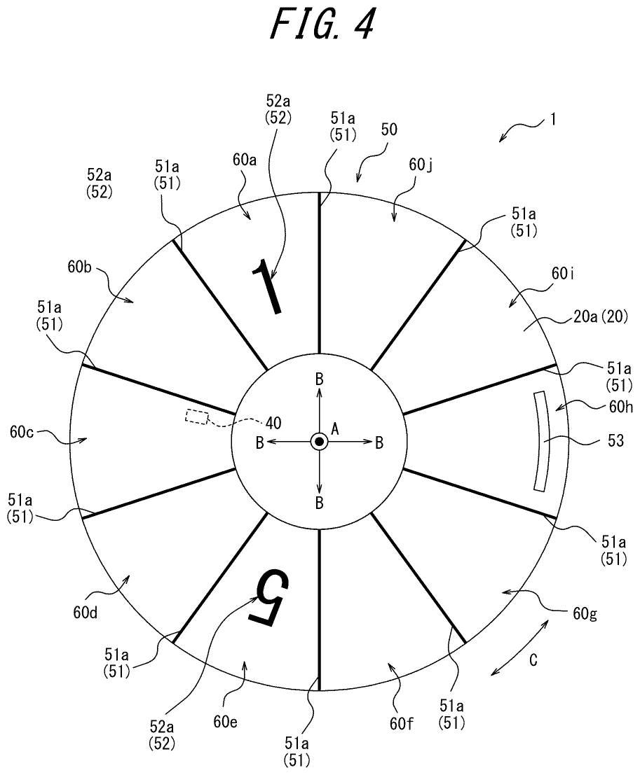

In other words, the area identification portions 52 only need to be configured so that each of the plurality of areas 60a to 60j partitioned by the area partition portions 51 can be uniquely identified through vision, and it may be arranged in only some of the plurality of areas 60a to 60j. FIGS. 3 and 4 illustrate examples of variants of the marking part 50 illustrated in FIG. 2. FIGS. 3 and 4 illustrate examples in which the numerical shape portions 52a, serve as the area identification portions 52, are provided in only some of the plurality of areas 60a to 60j. As illustrated in FIG. 3, the area identification portions 52 of the marking part 50 may be, for example, the numeral shape portions 52a that are arranged every other area of the plurality of areas 60a to 60j in the tire circumferential direction C. In addition, as long as the area identification portions 52 are configured so that each of the plurality of areas 60a to 60j partitioned by the area partition portions 51 is uniquely identifiable, as illustrated in FIG. 4, the area identification portions 52 may be numeric shape portions 52a that is not arranged every other area. Furthermore, for example, when only two area partition portions 51 are provided on the outer surface 20a to partition in the tire circumferential direction C into two areas, the area identification portion 52 may be arranged in only one of the two areas. That is, the area identification portion 52 is not limited to plurality. In this example, the area identification portion 52 does not need to be a numeral shape or a symbol shape, etc., and it is possible to uniquely identify each of the two areas based on whether or not it exists.

As described above, the marking part 50 of this embodiment comprises the plurality of area partition portions 51 arranged at intervals in the tire circumferential direction C to partition the entire area in the tire circumferential direction C into a plurality of areas 60a to 60j, and the one or more area identification portions 52 which make each of the plurality of areas 60a to 60j partitioned by the plurality of area partition portions 51 be uniquely identifiable. Thus, it is easy to identify the position in the tire circumferential direction C from the outside of the tire 1 through vision. Therefore, the position in the tire circumferential direction C of the target to be managed, e.g., the repaired location of a repaired tire, can be managed by associating it with each of the plurality of areas 60a to 60j which can be uniquely identified. In other words, the position in the tire circumferential direction C of the target to be managed can be easily identified from the outside of the tire 1.

The target to be managed and the position in the tire circumferential direction C where this target to be managed is located may be stored in a communication device 40 such as an RF tag, for example, by combining the identification information indicating the target to be managed and the area information indicating the area where the target to be managed is located among the plurality of areas 60a to 60j. In this way, it is possible to easily obtain the position in the tire circumferential direction C of the target to be managed by communicating with the communication device 40 from the outside of the tire 1 using a reader or the like. It is also preferable to associate the position in the tire circumferential direction C of the communication device 40 with the plurality of areas 60a to 60j to manage it separately. In this way, it is easy to identify the location of the communication device 40 embedded in the tire side portion 20 from the outside of the tire 1. In addition, there may be a display portion on the outer surface 20a of the area where the communication device 40 is located, indicating that the communication device 40 is located in that area. Such a display portion may be, for example, a protrusion provided on the outer surface 20a.

The information display portion 53 is, for example, a number, symbol, character, etc. that displays information about the tire 1, such as size information, serial number, and emblems. The information display portion 53 is, for example, composed of protrusions, recesses, etc. on the outer surface 20a of the side portion 20 of the tire 1, and is formed in an appearance that can be identified from the surroundings of the outer surface 20a of the tire side portion 20.

The following explains the area partition portion 51 and the area identification portion 52 in more detail.

As illustrated in FIG. 2, each of the plurality of area partition portions 51 of this embodiment is longer in the tire radial direction B than in the tire circumferential direction C. In this way, even if part of the outer surface 20a of the side portion 20 is covered with mud, etc., part in the tire radial direction B of the area partition portion 51 is easily visible from the outside of the tire 1, and the area partition portion 51 is prevented from being completely covered with mud, etc. In other words, the visibility of the area partition portion 51 from the outside can be enhanced. In particular, the area partition portion 51 preferably has a length of at least one-third of the height H of the tire 1 in the tire radial direction B. In this way, the visibility of the area partition portion 51 from the outside can be more enhanced. Furthermore, it is preferable that, in the radial direction B, the area partition portion 51 has a length of at least half the height H of the tire 1, and it is even more preferable that, in the radial direction B, the area partition portion 51 has a length of at least two-thirds the height H of the tire 1. In this way, the visibility of the area partition portion 51 from the outside can be further enhanced.

In addition, it is preferable that at least part of the area partition portion 51 is arranged on the inner side in the tire radial direction B of a position that is ½ the height H of the tire 1. In this way, the area partition portion 51 can be prevented from being completely covered by mud spattered from the ground.

As mentioned above, the area partition portions 51 of this embodiment are the line-shaped partition portions 51a extending linearly in the tire radial direction B, but this is not limited to this configuration. The area partition portions 51 may have a different shape, such as an elongated triangular or diamond shape in the tire radial direction B, for example. In addition, the line-shaped partition portions 51a, which serve as the area partition portions 51 in this embodiment, extend in a straight line in the tire radial direction B, but it may also be, for example, a wavy shape. However, as in the present embodiment, by forming the area partition portions 51 with the line-shaped partition portions 51a that extend in a straight line in the tire radial direction B, it is possible to partition the entire areas in tire circumferential direction C into the plurality of areas 60a to 60j with a simple structure.

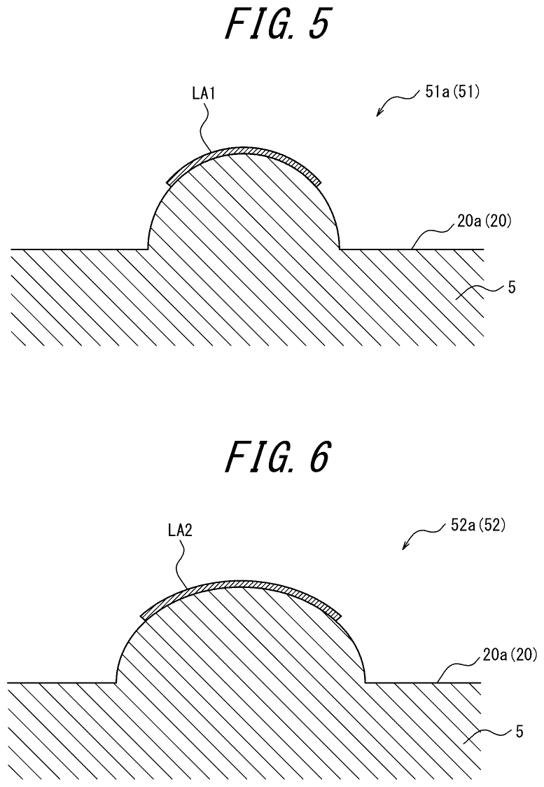

FIG. 5 is a cross-sectional view taken along line I-I in FIG. 2. As illustrated in FIG. 5, the area partition portion 51 preferably protrudes on the outer surface 20a of the side portion 20. In this way, the area partition portion 51 becomes less likely to be covered with mud, etc. Therefore, the visibility of the area partition portion 51 from the outside can be further enhanced.

In particular, the line-shaped partition portion 51a as the area partition portion 51 is preferably composed only of a convex curved surface that protrudes in an arc shape, in a cross-sectional view that is perpendicular to the extending direction thereof (FIG. 5). In this way, even if mud gets on the line-shaped partition portion 51a, it will easily fall along the convex curved surface, and the mud will be prevented from staying on the line-shaped partition portion 51a.

In addition, as in this embodiment, it is preferable that the area partition portion 51 has a different hue from surroundings in the tire circumferential direction C. In other words, it is preferable that the area partition portion 51 has a different hue from the position adjacent to the area partition portion 51 on the outer surface 20a of the side portion 20. In this way, the visibility of the area partition portion 51 from outside can be enhanced in bright environments such as during the day.

Furthermore, as in the present embodiment, the area partition portion 51 preferably comprises a light-emitting area LA1. By providing such light-emitting area LA1, it is possible to enhance the visibility of the area partition portion 51 from outside in dark environments such as at night or in dark places.

The light-emitting area LA1 of the area partition portion 51 is not limited to any particular area as long as it emits light externally. The light-emitting area LA1 may be, for example, a phosphorescent area that releases stored light. The phosphorescent area which serves as the light-emitting area LA1 may be formed of, for example, phosphorescent paint containing a phosphorescent material. In addition, the light-emitting area LA1 may be formed by mixing a phosphorescent material into a part of the rubber composition that constitutes the outer surface 20a of the side portion 20. The rubber composition containing the phosphorescent material may be attached to an unvulcanized tire and vulcanized together with the unvulcanized tire. In addition, the rubber composition containing the phosphorescent material may be attached to the tire after vulcanization, for example.

There are no restrictions on the type of the phosphorescent material used, and any known phosphorescent material may be used. For example, the following chemical formulae are examples of the phosphorescent material: SrAl₂O₄:Eu, Dy, Sr₄Al₁₄O₂₅: Eu, Dy, SrAl₂O₄:Eu, Dy+Sr₄Al₁₄O₂₅:Eu, Dy, Sr₄Al₁₄O₂₅:Eu, Dy+CaAl₂O₄:Eu, Nd, CaAl₂O₄:Eu, Nd, ZnS:Cu, Mn, Co, ZnS:Cu, etc.

The area partition portion 51 of this embodiment has a different hue from the position adjacent in the tire circumferential direction C on the outer surface 20a of the side portion 20, and also has the light-emitting area LA1 described above. As a result, the area partition portion 51 of this embodiment can be easily identified from the outside of the tire 1 in both bright environments such as during the day and dark environments such as at night or in dark places.

Also, as illustrated in FIG. 2, the plurality of line-shaped partition portions 51a which serve as the plurality of area partition portions 51 of this embodiment are arranged at equal intervals in the tire circumferential direction C, but this configuration is not limited to this. The plurality of area partition portions 51 may have different intervals of separation in the tire circumferential direction C, depending on the position in the tire circumferential direction C. In other words, the plurality of line-shaped partition portions 51a which serve as the plurality of area partition portions 51 do not have to be arranged at equal intervals in the tire circumferential direction C. However, as mentioned above, when the area partition portions 51 protrude on the outer surface 20a of the side portion 20, it is preferable that the plurality of area partition portions 51 are arranged at equal intervals in the tire circumferential direction C. In this way, the locations of the area partition portions 51 are evenly distributed in the tire circumferential direction C, therefore, it is possible to prevent the local change in rigidity in a part in the tire circumferential direction C, due to the bias on the distribution of the convex area partition portions 51 at the part in the tire circumferential direction C.

As illustrated in FIG. 2, it is also preferable that the area identification portion 52 is longer in the radial direction B than in the tire circumferential direction C, in the same way as for the area partition portion 51. In this way, even if part of the outer surface 20a of the side portion 20 is covered with mud, etc., part in the radial direction B of the area identification portion 52 is easily visible from the outside of the tire 1, and the area identification portion 52 is prevented from being completely covered with mud, etc. In other words, the visibility of the area identification portion 52 from the outside can be more enhanced. In particular, the area identification portion 52 preferably has a length of at least one-third of the height H of the tire 1 in the tire radial direction B. In this way, the visibility of the area identification portion 52 from the outside can be more enhanced. Furthermore, it is preferable that, in the radial direction B, the area identification portion 52 has a length of at least half the height H of the tire 1, and it is even more preferable that, in the radial direction B, the area identification portion 52 has a length of at least two-thirds the height H of the tire 1. In this way, the visibility of the area identification portion 52 from the outside can be further enhanced.

In addition, as illustrated in FIG. 2, it is preferable that at least part of the area identification portion 52 is arranged on the inner side in the tire radial direction B of a position that is ½ the height H of the tire 1. In this way, the area identification portion 52 can be prevented from being completely covered by mud spattered from the ground.

In addition, FIG. 6 is a cross-sectional view taken along line II-II in FIG. 2. As illustrated in FIG. 6, the area identification portion 52 preferably protrudes on the outer surface 20a of the side portion 20. In this way, the area identification portion 52 becomes less likely to be covered with mud, etc. Therefore, the visibility of the area identification portion 52 from the outside can be further enhanced.

In particular, the area identification portion 52 is preferably composed of a convex curved surface that protrudes in an arc shape so that the center in the tire circumferential direction C protrudes the most, in the cross-sectional view (see FIG. 6) of the arbitrary cross-section that is orthogonal to the tire radial direction B at the position of the area identification portion 52, of the cross-sectional view orthogonal to the side view of the tire illustrated in FIG. 2. In this way, even if mud gets on the area identification portion 52, it will easily fall along the convex curved surface, and the mud will be prevented from remaining on the area identification portion 52.

In addition, as in this embodiment, it is preferable that the area identification portion 52 has a different hue from surroundings in the tire circumferential direction C. In other words, it is preferable that the area identification portion 52 has a different hue from the position adjacent to the area identification portion 52 on the outer surface 20a of the side portion 20. In this way, the visibility of the area identification portion 52 from the outside can be enhanced.

Furthermore, as in the present embodiment, the area identification portion 52 preferably comprises a light-emitting area LA2. By providing such light-emitting area LA2, it is possible to enhance the visibility of the area identification portion 52 from outside in dark environments such as at night or in dark places.

The light-emitting area LA2 of the area identification portion 52 is not limited to any particular area as long as it emits light externally. The light-emitting area LA2 may be, for example, a phosphorescent area that releases stored light. The phosphorescent area which served as the light-emitting area LA2 may have the same structure as the light-emitting area LA1 in the area partition portion 51 described above.

The area identification portion 52 of this embodiment has a different hue from the position adjacent in the tire circumferential direction C on the outer surface 20a of the side portion 20, and also has the light-emitting area LA2 described above. As a result, the area identification portion 52 of this embodiment can be easily identified from the outside of the tire 1 in both bright environments such as during the day and dark environments such as at night or in dark places.

Also, as illustrated in FIG. 2, the plurality of numeral shape portions 52a that serve as the plurality of area identification portions 52 of this embodiment are arranged at equal intervals in the tire circumferential direction C, but this configuration is not limited to this. The plurality of area identification portions 52 do not have to be arranged at equal intervals in the tire circumferential direction C. However, when the area identification portions 52 protrude on the outer surface 20a of the side portion 20 as mentioned above, it is preferable that the plurality of area identification portions 52 are arranged at equal intervals in the tire circumferential direction C. In this way, the locations of the area identification portions 52 are evenly distributed in the tire circumferential direction C, therefore, it is possible to prevent the local change in rigidity in a part in the tire circumferential direction C, due to the bias on the distribution of the convex area identification portions 52 at the part in the tire circumferential direction C.

In addition, as illustrated in FIGS. 3 and 4, it is preferable that the area identification portions 52 are arranged in only half or fewer of the plurality of areas 60a to 60j that are partitioned by the plurality of area partition portions 51. When the area identification portions 52 protrude on the outer surface 20a of the side portion 20 as mentioned above, the rigidity is slightly higher at the position where the area identification portions 52 are arranged in the tire circumferential direction C. Therefore, by having the area identification portions 52 be arranged in only half or less of the plurality of areas 60a to 60j that are partitioned by the plurality of area partition portions 51, it is possible to suppress the variation in rigidity in the tire circumferential direction C. The number of the area identification portions 52 is preferably as small as possible, as long as each of the plurality of areas 60a to 60j that are partitioned by the plurality of area partition portions 51 is uniquely identifiable. From the above, in terms of improving the discriminability of plurality of areas 60a to 60j and suppressing the variation in rigidity in the tire circumferential direction C, it is particularly preferable that the area identification portions 52 are arranged every other area in the tire circumferential direction C, as illustrated in FIG. 3.

As illustrated in FIG. 2, it is preferable that the area partition portions 51 and the area identification portions 52 are arranged so as not to overlap the information display portion 53. In this way, a decrease in visibility of the information displayed by the information display portion 53 can be suppressed. Specifically, the area partition portions 51 and the area identification portions 52 may be, for example, arranged in different positions from the information display portion 53 in at least one direction of the tire radial direction B and the tire circumferential direction C.

### Second Embodiment

Next, a tire 201 as the second embodiment will be explained. The configuration of the tire 201 in a cross-section in the tire width direction is the same as that of the tire 1 in the first embodiment described above. In this embodiment, the tire 201 differs from the tire 1 described above (see FIGS. 1 to 6) in the configuration of the marking part 250 provided on the outer surface 20a of the side portion 20, and the other configurations are the same. Therefore, only the marking part 250, which differs from that of the tire 1 will be explained here, and the explanation of the other identical components will be omitted.

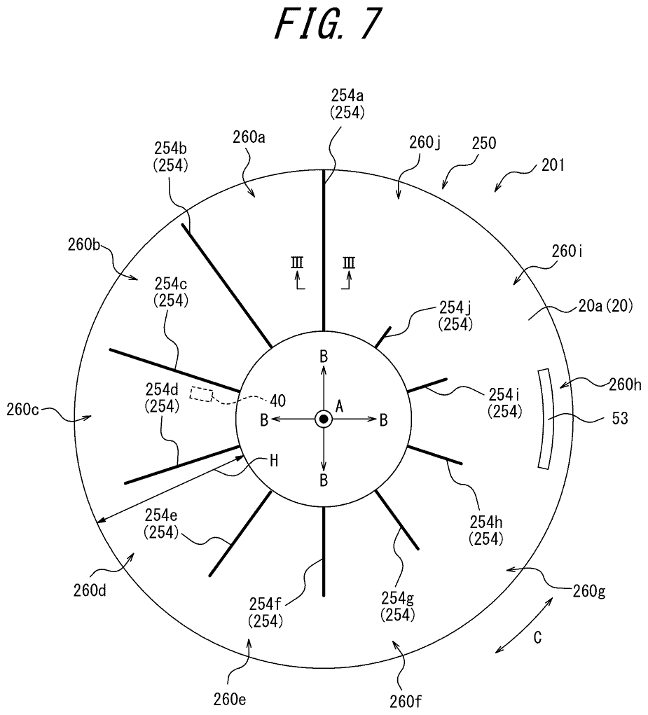

FIG. 7 is a side view of the tire 201, viewed along the tire width direction A. As illustrated in FIG. 7, the marking part 250 is configured to be visually recognizable from the outside of the tire 201 through vision.

As illustrated in FIG. 7, the marking part 250 of this embodiment comprises a plurality of area partition identification portions 254 and an information display portion 53. The information display portion 53 is the same as the first embodiment described above, the explanation will be omitted here.

As illustrated in FIG. 7, the plurality of area partition identification portions 254 are arranged at intervals in the tire circumferential direction C and divide the entire tire circumferential direction C into a plurality of areas 260a to 260j that can be uniquely identified. In other words, the area partition identification portion 254 combines the functions of both the area partition portion 51 (see FIG. 2, etc.) and the area identification portion 52 (see FIG. 2, etc.) of the first embodiment described above.

As illustrated in FIG. 7, the plurality of area partition identification portions 254 of this embodiment are arranged at equal intervals in the tire circumferential direction C with different appearances that are mutually identifiable. More specifically, the plurality of area partition identification portions 254 of this embodiment are ten line-shaped partition identification portions 254a to 254j that extend in the tire radial direction B on the outer surface 20a of the side portion 20 and have different lengths in the tire radial direction B. The ten line-shaped partition identification portions 254a to 254j are arranged at equal intervals in the tire circumferential direction C. In other words, the center angles of each of the plurality of areas 260a to 260j, which are partitioned by the ten line-shaped partition identification portions 254a to 254j, are equal. In this embodiment, the ten line-shaped partition identification portions 254a to 254j are arranged at equal intervals in the tire circumferential direction C, however, the lengths in the tire radial direction B gradually decrease in the tire circumferential direction C in the order from the line-shaped partition identification portion 254a to the line-shaped partition identification portion 254j. In this way, the plurality of line-shaped partition identification portions 254a to 254j, which serve as the plurality of area partition identification portions 254 of this embodiment, are in mutually identifiable appearances. Therefore, even if the plurality of line-shaped partition identification portions 254a to 254j are arranged at equal intervals in the tire circumferential direction C, each of the plurality of areas 260a to 260j partitioned by the plurality of line-shaped partition identification portions 254a to 254j can be uniquely identified.

In this way, by making the marking part 250 comprise the area partition identification portions 254, it is not necessary to have a configuration where the area partition portions 51 (see FIG. 2, etc.) and the area identification portion 52 (see FIG. 2, etc.) are provided separately, as in the first embodiment described above. In other words, compared to the marking part 50 of the first embodiment described above (see FIG. 2, etc.), the configuration of the marking part 250 can be simplified.

In this embodiment, the plurality of area partition identification portions 254 are configured to be mutually identifiable by using ten line-shaped partition identification portions 254a to 254j, each of which has a different length in the tire radial direction B, however, the configuration that allows for mutual identification is not limited to this configuration. The plurality of area partition identification portions 254 may be mutually identifiable by, for example, differing in shape other than in the length in the tire radial direction B. In addition, in this embodiment, the plurality of area partition identification portions 254 that can be mutually identified are arranged at equal intervals in the tire circumferential direction C, but this configuration is not limited to this. The plurality of area partition identification portions 254 that are mutually identifiable do not have to be arranged at equal intervals in the tire circumferential direction C.

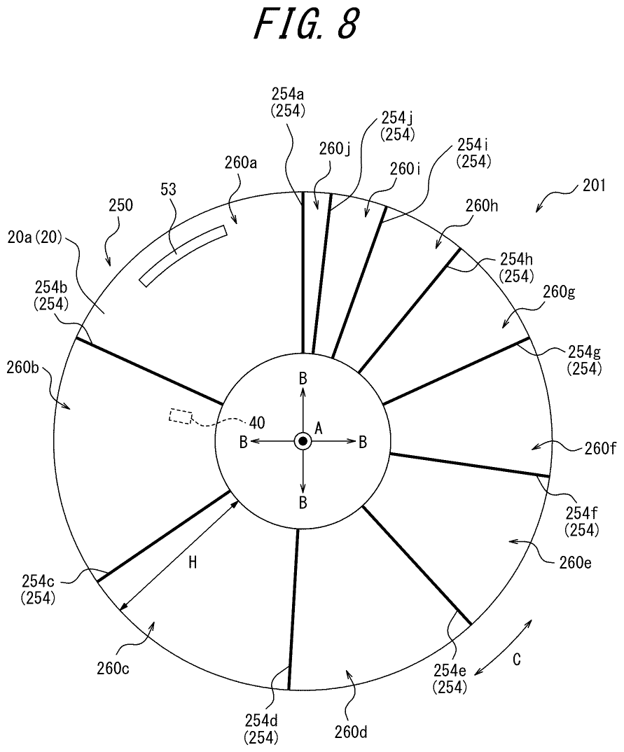

In addition, the plurality of area partition identification portions 254 are not limited to the configuration illustrated in FIG. 7. FIG. 8 illustrates a variant example of the marking part 250. The plurality of area partition identification portions 254 of the marking part 250 illustrated in FIG. 8 are arranged at different intervals in the tire circumferential direction C with the same appearances that are mutually unidentifiable. More specifically, the plurality of area partition identification portions 254 illustrated in FIG. 8 are ten line-shaped partition identification portions 254a to 254j that extend in the radial direction B on the outer surface 20a of the side portion 20 and have equal lengths in the tire radial direction B. In the example illustrated in FIG. 8, the ten line-shaped partition identification portions 254a to 254j are in appearances that are mutually unidentifiable, however, the distance between adjacent two line-shaped partition identification portions gradually decreases in the tire circumferential direction C in the order from the line-shaped partition identification portion 254a to the line-shaped partition identification portion 254j. In this way, even if the plurality of line-shaped partition identification portions 254a to 254j are mutually unidentifiable on the outer surface 20a of the side portion 20 illustrated in FIG. 8 because the plurality of line-shaped partition identification portions 254a to 254j which serve as the plurality of area partition identification portions 254 are not arranged at equal intervals on the outer surface 20a of the side 20, each of the plurality of areas 260a to 260j can be uniquely identified.

In FIG. 8, the distance between two adjacent line-shaped partition identification portions in the tire circumferential direction C gradually decreases in the order from the line-shaped partition identification portion 254a to the line-shaped partition identification portion 254j, however, the distance between two adjacent line-shaped partition identification portions may gradually increase in the above order, for example. In addition, as long as each of the plurality of areas 260a to 260j can be uniquely identified, the distance between the two adjacent line-shaped partition identification portions may increase and decrease in the order described above.

In this way, by devising at least one of the respective appearances and arrangement relationships of the plurality of area partition identification portions 254, the entire area in the tire circumferential direction C of the outer surface 20a of the side portion 20 can be partitioned into the plurality of areas 260a to 260j that can be uniquely identified respectively. However, the more the number of the area partition identification portions 254 increases, the smaller the center angle of each of the plurality of areas divided by the area partition identification portions 254 becomes, and the smaller the maximum length of each of the plurality of areas in the tire circumferential direction C becomes. Therefore, even the plurality of area partition identification portions 254 are not arranged at equal intervals in the tire circumferential direction C, it may be difficult to uniquely identify each area from the outside of the tire 201. For this reason, it is preferable that the marking part 250 is in a manner that at least the plurality of area partition identification portions 254 can be mutually identified, as illustrated in FIG. 7.

As illustrated in FIGS. 7 and 8, each of the plurality of area partition identification portions 254 is longer in the tire radial direction B than in the tire circumferential direction C. In this way, even if part of the outer surface 20a of the side portion 20 is covered with mud, etc., part in the tire radial direction B of the area partition identification portion 254 is easily visible from the outside of the tire 201, and the area partition identification portion 254 is prevented from being completely covered with mud, etc. In other words, the visibility of the area partition identification portion 254 from the outside can be improved. In particular, the area partition identification portion 254 preferably has a length of at least one-third of the height H of the tire 201 in the tire radial direction B. In this way, the visibility of the area partition identification portion 254 from the outside can be more enhanced. Furthermore, it is preferable that, in the radial direction B, the area partition identification portion 254 has a length of at least half the height H of the tire 1, and it is even more preferable that, in the radial direction B, the area partition identification portion 254 has a length of at least two-thirds the height H of the tire 1. In this way, the visibility of the area partition identification portion 254 from the outside can be further enhanced.

In addition, it is preferable that at least part of the area partition identification portion 254 is arranged on the inner side in the tire radial direction B of a position that is ½ the height H of the tire 1. In this way, the area partition identification portion 254 can be prevented from being completely covered by mud spattered from the ground.

As mentioned above, the plurality of area partition identification portions 254 illustrated in FIGS. 7 and 8 are line-shaped partition identification portions 254a to 254j extending linearly in the tire radial direction B, but they are not limited to this configuration. The area partition identification portions 254 may have a different shape, such as an elongated triangular or diamond shape in the tire radial direction B, for example. In addition, the respective line-shaped partition identification portions 254a to 254j, which serves as the area partition identification portion 254 as illustrated in FIGS. 7 and 8, extends in a straight line in the tire radial direction B, however, may be in a wavy shape, for example. However, as illustrated in FIGS. 7 and 8, by making the area partition identification portions 254 the line-shaped partition identification portions 254a to 254j extending in a straight line in the tire radial direction B, it is possible to partition the entire area in the tire circumferential direction C into the plurality of areas 260a to 260j that can be uniquely identified with a simple configuration.

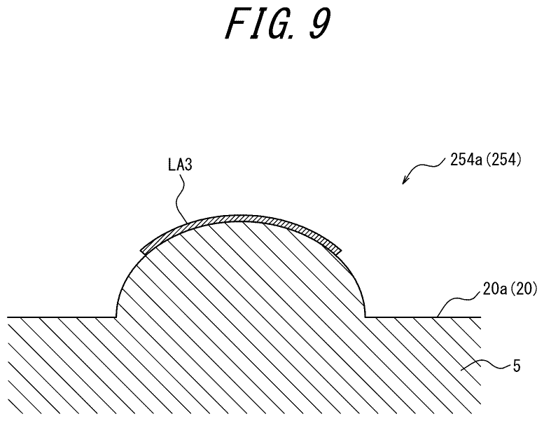

FIG. 9 is a cross-sectional view taken along line III-III in FIG. 7. As illustrated in FIG. 9, the area partition identification portion 254 preferably protrudes on the outer surface 20a of the side portion 20. In this way, the area partition identification portion 254 becomes less likely to be covered with mud, etc. Therefore, the visibility of the area partition identification portion 254 from the outside can be enhanced.

In particular, it is preferable that each of the line-shaped partition identification portions 254a to 254j, which serve as the area partition identification portions 254, is composed only of convex curved surfaces that protrude in an arc shape in a cross-sectional view (see FIG. 9) that is orthogonal to the extending direction thereof. In this way, even if mud gets on the line-shaped partition identification portions 254a to 254j, it will easily fall along the convex curved surface, and it will be possible to suppress the mud from staying on the line-shaped partition identification portions 254a to 254j.

In addition, it is preferable that the area partition identification portion 254 has a different hue from surroundings in the tire circumferential direction C. In other words, it is preferable that the area partition identification portion 254 has a different hue from the position adjacent to the area partition identification portion 254 on the outer surface 20a of the side portion 20. In this way, the visibility of the area partition identification portion 254 from the outside can be enhanced.

Furthermore, the area partition identification portion 254 preferably comprises a light-emitting area LA3. By providing such light-emitting area LA3, it is possible to enhance the visibility of the area partition identification portion 254 from outside in dark environments such as at night or in dark places.

The light-emitting area LA3 of the area partition identification portion 51 is not limited to any particular area as long as it emits light externally. The light-emitting area LA3 may be, for example, a phosphorescent area that releases stored light. The phosphorescent area which serves as the light-emitting area LA3 may be formed of, for example, phosphorescent paint containing a phosphorescent material. In addition, the light-emitting area LA3 may be formed by mixing a phosphorescent material into a part of the rubber composition that constitutes the outer surface 20a of the side 20. The rubber composition containing the phosphorescent material may be attached to an unvulcanized tire and vulcanized together with the unvulcanized tire. In addition, the rubber composition containing the phosphorescent material may be attached to tires after vulcanization, for example.

There are no restrictions on the type of the phosphorescent material used, and any known phosphorescent material may be used. For example, the following chemical formulae are examples of the phosphorescent material: SrAl₂O₄:Eu, Dy, Sr₄Al₁₄O25:Eu, Dy, SrAl₂O4:Eu, Dy+Sr₄Al14O₂₅:Eu, Dy, Sr₄Al₁₄O₂₅:Eu, Dy+CaAl₂O4:Eu, Nd, CaAl₂O4:Eu, Nd, ZnS:Cu, Mn, Co, ZnS:Cu, etc.

The area partition identification portion 254 of illustrated in FIGS. 7 and 8 has a different hue from the position adjacent in the tire circumferential direction C on the outer surface 20a of the side portion 20, and also has the light-emitting area LA3 described above. As a result, the area partition identification portion 254 can be easily identified from the outside of the tire 201 in both bright environments such as during the day and dark environments such as at night or in dark places.

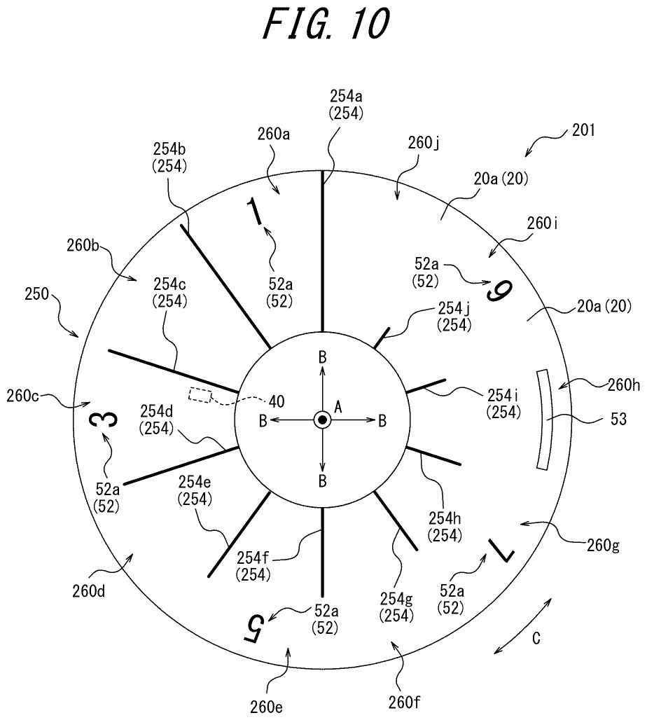

The tire according to this disclosure is not limited to the specific configuration provided in the above-mentioned embodiments and variations, and various variations, modifications, and combinations are possible as long as they do not deviate from the scope of the claims. For example, the marking part 250 of the tire 201 illustrated in FIGS. 7 and 8 comprises the plurality of area partition identification portions 254, but in addition to this, the area identification portion 52 illustrated in FIG. 2, etc. may be further provided (see FIG. 10). In this way, the position in the tire circumferential direction C on the outer surface 20a of the side portion 20 can be more easily identified from the outside of the tire 201.

### INDUSTRIAL APPLICABILITY

This disclosure relates to a tire.

### REFERENCE SIGNS LIST

1, 201 Tire
1a Tread portion
1b Sidewall portion
1c Bead portion
2 Bead member
2a Bead core
2b Stiffener
3 Carcass
3a Carcass ply
4 Belt
4a-4d Belt layer
5 Side rubber
6 Tread rubber
6a Tread surface
6a1 Lug groove
6a2 Circumferential groove
7 Inner liner
13 Ply main body portion
14 Ply turn-up portion
20 Side portion
20a Outer surface of side portion
40 Communication device
50, 250 Marking part
51 Area partition portion
51a Line-shaped partition portion (Example of Area partition portion)
52 Area identification portion
52a Numeral shape portion (Example of Area identification portion)
53 Information display portion
60a-60j Area partitioned by Area partition portion
100 Tire cavity
254 Area partition identification portion
254a-254j Line-shaped partition identification portion (Example of area partition identification portion)
260a-260j Area partitioned by Area partition identification portion
A Tire width direction
B Tire radial direction
C Tire circumferential direction
CL Tire equatorial plane
H Tire height
LA1-LA3 Light-emitting area
TE Tread edge

1. A tire comprising a marking part provided on an outer surface of a side portion, that is visually recognizable from an outside of the tire through vision, wherein
the marking part comprises at least one of:
a plurality of area partition portions arranged at intervals in the tire circumferential direction to partition an entire area in the tire circumferential direction into a plurality of areas; and one or more area identification portions which make each of the plurality of areas partitioned by the plurality of area partition portions be uniquely identifiable, and
a plurality of area partition identification portions arranged at intervals in the tire circumferential direction to partition an entire area in the tire circumferential direction into a plurality of areas each of which is uniquely identifiable.

2. The tire as described in claim 1, wherein
the marking part comprises the plurality of area partition portions and the one or more area identification portions, and
each of the plurality of area partition portions is longer in a tire radial direction than in the tire circumferential direction.

3. The tire as described in claim 2, wherein each of the plurality of area partition portions has a length of at least one-third of a height of the tire in the tire radial direction.

4. The tire as described in claim 2, wherein each of the plurality of area partition portions protrudes on the outer surface of the side portion.

5. The tire as described in claim 2, wherein each of the plurality of area partition portions has a different hue from surroundings in the tire circumferential direction.

6. The tire as described in claim 2, wherein each of the plurality of area partition portions comprises a light-emitting area.

7. The tire as described in claim 2, wherein the plurality of area partition portions are arranged at equal intervals in the tire circumferential direction.

8. The tire as described in claim 2, wherein each of the plurality of area partition portions is a line-shaped partition portion that extends linearly in the tire radial direction.

9. The tire as described in claim 2, wherein the one or more area identification portions are arranged in only half or fewer of the plurality of areas that are partitioned by the plurality of area partition portions.

10. The tire as described in claim 2, wherein the one or more area identification portions protrude on the outer surface of the side portion.

11. The tire as described in claim 1 wherein, the marking part comprises the plurality of area partition identification portions, and
the plurality of area partition identification portions are arranged at equal intervals in the tire circumferential direction with different appearances that are mutually identifiable.

12. The tire as described in claim 1 wherein, the marking part comprises the plurality of area partition identification portions, and
the plurality of area partition identification portions are arranged at different intervals in the tire circumferential direction with same appearances that are mutually unidentifiable.

13. The tire as described in claim 3, wherein each of the plurality of area partition portions protrudes on the outer surface of the side portion.

14. The tire as described in claim 3, wherein each of the plurality of area partition portions has a different hue from surroundings in the tire circumferential direction.

15. The tire as described in claim 3, wherein each of the plurality of area partition portions comprises a light-emitting area.

16. The tire as described in claim 3, wherein the plurality of area partition portions are arranged at equal intervals in the tire circumferential direction.

17. The tire as described in claim 3, wherein each of the plurality of area partition portions is a line-shaped partition portion that extends linearly in the tire radial direction.

18. The tire as described in claim 3, wherein the one or more area identification portions are arranged in only half or fewer of the plurality of areas that are partitioned by the plurality of area partition portions.

19. The tire as described in claim 3, wherein the one or more area identification portions protrude on the outer surface of the side portion.
